(19) United States
(12) Patent Application Publication
(10) Pub. No.: US 2011/0017778 A1
(43) Pub. Date: Jan. 27, 2011

(54) Automatic Dispenser

(76) Inventors: Fedor Kadiks, Hillegrom (NL); Rocky Hsieh, Hsin-Chu City (TW)

Correspondence Address: MOORE & VAN ALLEN PLLC, P.O. BOX 13706, Research Triangle Park, NC, 27709, US

(21) Appl. No.: 12/021,937

(22) Filed: Jan. 29, 2008

Related U.S. Application Data
(60) Provisional application No. 60/898,676, filed on Jan. 30, 2007.

(51) Int. Cl. B67D 7/76; B65D 88/54

(52) U.S. Cl. 222/190; 222/333; 222/325

(57) ABSTRACT

An automatic dispenser assembly is disclosed. The dispenser assembly is adapted to use a replaceable fluid container having a foam pump. The dispenser assembly includes an adapter for securing and positioning a foam pump in the dispenser assembly. The dispenser assembly also includes an actuating mechanism to automatically actuate the foam pump and a control circuit to control the operation of the actuating mechanism. When a sensor assembly detects a hand or other object in the proximity of the dispenser assembly in a position to receive a dose of foam, the actuating mechanism and the control circuit cooperate to drive the foam pump so as to create foam and to return the foam pump to a closed position that prevents leakage.

### CROSS REFERENCE TO RELATED APPLICATIONS

The present patent document claims the benefit of the filing date under 35 U.S.C. §119(e) of Provisional U.S. Patent Application Ser. No. 60/898,676, titled, “Automatic Dispenser,” filed on Jan. 30, 2007, which is hereby incorporated by reference.

This patent is related to co-pending, U.S. patent application Ser. No. 29/272,047, titled, “Nozzle for a Foam Pump,” filed on Jan. 30, 2007; and U.S. patent application Ser. No. 29/272,049, titled, “Nozzle for a Foam Pump,” filed on Jan. 30, 2007. The entire contents of these related patent applications are incorporated herein by reference for all purposes.

### FIELD OF THE INVENTION

The present invention relates to automatic dispensers. More specifically, the present invention relates to automatic dispensers for dispensing soap in a foam form.

### BACKGROUND OF THE INVENTION

Hand foam soap dispensers typically require a user to depress the nozzle of a foam pump screwed into an opening at the top of a table top reservoir in order to dispense foam soap. Once the nozzle is released, the foam pump is spring biased so as to return to a rest position. Such foam pumps are inexpensive and are produced in large quantities. An example of such a foam pump is a commercial foam pump supplied by Airspray International, Inc. of Pompano Beach, Fla., USA. and identified as Model M5.

It is also known to provide a manual foam soap dispenser in which the fluid reservoir is located above the foam pump. A user presses a pump or pulls the handle to dispense foam soap. Such dispensers are shown, for example, in U.S. Pat. No. 6,053,364, U.S. patent application Ser. No. 10/841,944 (Pub. No. 2005/0006408), and U.S. patent application Ser. No. 10/841,945 (Pub. No. 2005/0006409), the disclosures of which are incorporated herein by reference in their entirety.

However, these manual dispensers fail to adequately ensure that the foam pump is closed properly at the end of every stroke cycle so as to prevent leaking. These dispensers may allow soap to drip out of the dispenser after a use. This dripping creates an unappealing and messy environment and discourages the use of the dispenser. Thus, it is desirable to force the foam pump to return to a closed position that prevents leakage or dripping of excess liquid soap.

In addition, users who fear that they may contract diseases by the physical contact may not use a manual dispenser. In this situation, the usefulness of the dispenser is not completely realized. As a result, touch-free activation is a desired quality in the dispenser.

These and other objectives, advantages, and features of the present invention will become apparent from the following description and claims, taken in conjunction with the accompanying drawings.

### BRIEF SUMMARY

In one embodiment of the present invention, an automatic dispenser assembly is disclosed. The dispenser assembly is adapted to use a replaceable fluid container having a foam pump. The dispenser assembly includes an adapter for securing and positioning a foam pump in the dispenser assembly. The dispenser assembly also includes an actuating mechanism to automatically actuate the foam pump and a control circuit to control the operation of the actuating mechanism. When a sensor assembly detects a hand or other object in the proximity of the dispenser assembly in a position to receive a dose of foam, the actuating mechanism and the control circuit cooperate to drive the foam pump so as to create foam and to return the foam pump to a closed position that prevents leakage.

### BRIEF DESCRIPTION OF THE DRAWINGS

FIG. 1 is a perspective view of a dispenser assembly and a foam pump in accordance with an embodiment of the present invention;

FIG. 2 is a perspective view of the foam pump of FIG. 1;

FIG. 3 is a side view, in partial cross section, of the foam pump of FIG. 1 in a rest position;

FIG. 4 is a side view, in partial cross section, of the foam pump of FIG. 1 in a closed position position;

FIG. 5 is a perspective view of the dispenser assembly of FIG. 1 without the foam pump;

FIG. 6 is a front view of the dispenser assembly of FIG. 5;

FIG. 7 is a bottom view of the dispenser assembly of FIG. 5;

FIG. 8 is a perspective view of the actuating mechanism of the dispenser assembly of FIG. 5;

FIG. 9 is an exploded view of the actuating mechanism FIG. 8;

FIG. 10 is a perspective view of the hammer mechanism of the actuating mechanism of FIG. 8;

FIG. 11 is a perspective view of the driving cam and the switch cam of the actuating mechanism of FIG. 8; and

FIG. 12 illustrates the control circuit of the dispenser assembly of FIG. 1.

### DETAILED DESCRIPTION OF THE INVENTION

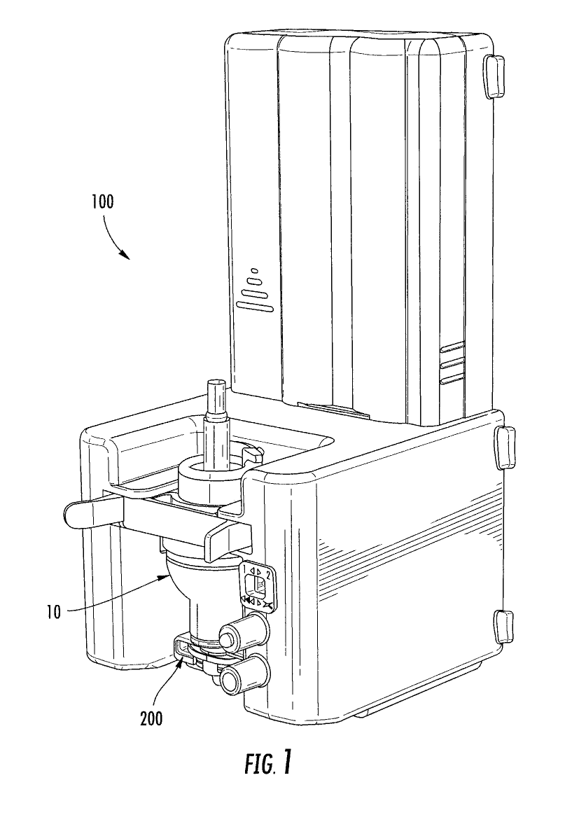

Referring to FIG. 1, a dispenser assembly 100 for dispensing foam soap is disclosed in accordance with one embodiment of the present invention. However, it will be understood that other foaming products, for example cosmetics products, personal care products, and cleaning products, can also be dispensed using the dispenser assembly 100 without departing from the scope of the invention. Further, it will be understood that the dispenser assembly 100 is suited for dispensing other types of non-foaming products, such as sprays or lotions.

### The Foam Pump Assembly

In the embodiment of FIG. 1, the dispenser 100 is designed to interact with a foam pump 10 that can be held in a closed position to prevent leakage. Preferably, the foam pump 10 is of a type that is used for hand soap dispensers for creating foam soap from liquid soap without the use of gas propellants. The dispenser assembly 100 actuates the foam pump 10 to create foam soap from liquid soap stored in a container 30 and to dispense the foam soap, as described below. The dispenser assembly 100 then returns the foam pump 10 to a closed position that prevents leakage or dripping of excess liquid soap.

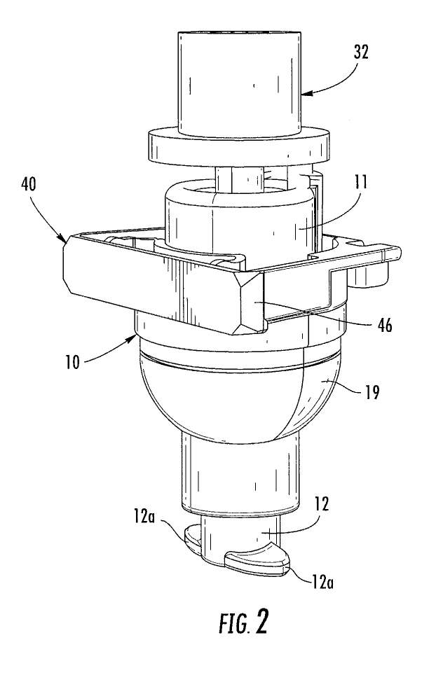

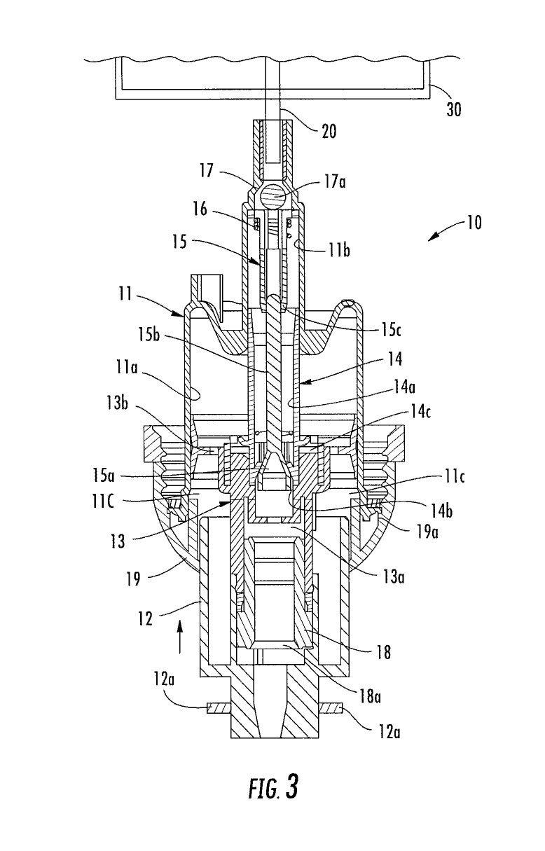

FIGS. 2-4 illustrates an exemplary foam pump 10 for creating foam soap by mixing liquid soap with air. The foam pump 10 includes a pump chamber 11. The pump chamber 11 has a generally cylindrical portion that defines an air chamber 11a and a reduced diameter portion that defines a fluid chamber 11b. At its upper end, the fluid chamber 11b is in fluid communication with the container 30 through a suction tube 20. The container 30 preferably has a flexible construction, for example, in the shape of plastic bag suitable for storing liquid soap.

An air piston 13 is slidably received in the air chamber 11a. The head of the air piston 13 is dimensioned so as to sealingly engage the inner walls of the air chamber 11a. One or more closable valves 13b, for example flap valves, are formed in the head of the air piston 13 for drawing air into the air chamber 11a from atmosphere, as described below. The body of the air piston 13 has a reduced diameter and extends out of the air chamber 11a. A longitudinally extending central bore 13a is formed in the air piston 13. A net holder 18 is mounted in the lower end of the central bore 13a. The net holder 18 is a cylindrical member including one or more mesh, screen or net elements 18a disposed therein.

A liquid piston 14 is attached to the head of the air piston 13 and is slidably disposed in the fluid chamber 11b. The liquid piston 14 sealingly engages the inner walls of the fluid chamber 11b. The liquid piston 14 defines a longitudinally extending central bore 14a, including a mixing chamber 14b at its lower end. One or more openings 14c, for example, in the shape of grooves in the liquid piston 14, are formed between the air piston 13 and the liquid piston 14 to provide an air passage between the air chamber 11a and the mixing chamber 14b. The central bore 14a of the liquid piston 14 is in fluid communication with the central bore 13a of the air piston 13. Together, the central bores 13a and 14a form an internal fluid passageway between the container 30 and the nozzle 12 of the foam pump 10.

A telescopic metering assembly 15 is disposed within the central bore 14a of the liquid piston 14, and includes a tapered or frustoconical end member 15a, an inner rod 15b, and a tubular plug 15c. The frustoconical end member 15a extends from the lower end of the inner rod 15b. The frustoconical end member 15a travels in the mixing chamber 14b that is defined in the lower end of the central bore 14a of the liquid piston 14. A seat portion of the mixing chamber 14b has tapered walls which can engage the frustoconical end member 15a to form a seal. The upper end of the inner rod 15b opposite the frustoconical end member 15a is slidably received within the tubular plug 15c, which extends beyond the end of the liquid piston 14 and into the fluid chamber 11a.

A spring 16 is mounted over the inner rod 15b and the plug 15c of the metering assembly so as to bias the plug 15c away from the liquid piston 14. One end of the spring 16 presses against a flange on the upper end of the plug 15c. The other end of the spring 16 presses against a shoulder portion defined in the central bore 14a of the liquid piston 14. The liquid piston 14 and metering assembly 15 are dimensioned and arranged so that when the spring 16 is unloaded and/or fully extended in its uncompressed state, the frustoconical end member 15a is received in the seat portion of the mixing chamber 14b.

A ball check valve 17 is disposed in the upper end of the fluid chamber 11b, including a ball 17a that is supported on the flange on the upper end of the plug 15c. When the spring 16 is compressed, the spring 16 biases the ball 17a via the plug 15e into a ball seat formed in the upper end of the fluid chamber 11b so as to block the flow of liquid soap from the container 30 into the foam pump 10.

The nozzle 12 of the foam pump 10 is mounted over the reduced diameter body portion of the air piston 13 and the net holder 18. The nozzle 12 includes a pair of protrusions or winged elements 12a that are received by the actuating mechanism 200 of the dispenser assembly 100 to allow the foam pump 10 to be controlled by the actuating mechanism of the dispenser assembly 100, as described below. It will be understood that the winged elements 12a can assume different configurations, shapes, sizes, etc., as long as the nozzle 12 can be connected to the actuating mechanism of the dispenser assembly 100, so as to permit actuation of the foam pump 10.

The foam pump 10 is connected to a coupling piece 40 to allow the foam pump 10 to be secured to the housing of the dispenser assembly 100, as described below. In this embodiment, the foam pump 10 is screwed to a coupling piece 40 through complementary threading located on both the foam pump 10 and the coupling piece 40. The coupling piece 40 includes a threaded neck and the foam pump 10 includes a matching thread applied to the inside of a cap 19. The threaded cap 19 is disposed over portions of the nozzle 12 and the air chamber 11a in a manner such that a protruding edge of the air chamber 11a rests on a stop edge 19a that is formed on the inside of the threaded cap 19. Upon screwing together the foam pump 10 and the coupling piece 40, the front edge of the coupling piece 40 comes to rest against the protruding edge of the air chamber 11a so that the pump chamber 11 is pressed against the cap 19. The pump chamber 11 is thereby clamped between the threaded coupling piece 40 and the stop edge 19a on the inside of cap 19. Foam pumps with such a threaded cap 30 are produced in large quantities for screwing onto the threaded neck of the bottle of a hand soap dispenser. Thus, it is possible to use the foam pump 10 in both soap dispensers according to the present invention and hand soap dispensers, thereby achieving advantages of scale in production. Of course it will be recognized that the foam pump 10 may be attached to the coupling piece 40 by other means, such as a snap or click connection.

In this embodiment, the coupling piece 40 also helps to prevent contamination of the foam pump 10. In particular, the foam pump 10 may include an air passage (not shown) located in the outer wall of the air chamber 13 for use in a hand soap dispenser. When used in a hand soap dispenser with a bottle as a container, the air passage serves to aerate the bottle by forming an open connection between the foam pump 10 and the contents of the bottle. However, when a flexible container 30 is used, it is not necessary to aerate the container because it collapses as liquid soap is pumped out of it. Thus, in the present embodiment, the coupling piece 40 is adapted to close off the air passage so as to prevent contamination of the foam pump 10 and of the soap flowing through it. Upon screwing together the foam pump 10 and the coupling piece 40, at least a part of the inner surface of the coupling piece 40 abuts the outer wall of the air chamber 13 in such a manner that the air passage 28 is closed off.

The foam pump 10 is then connected in a substantially airtight manner to the container 30 in such a manner that soap can only flow through the foam pump 10 via the suction tube 20. In the present embodiment, the foam pump 10 is connected to the container 30 via a fitting 32 that is attached to the container 30. The fitting 32 can be, for example, thermally welded or bonded to the container 30. The fitting 32 includes a central opening that allows the suction tube 20 to pass therethrough and to emerge in the interior of the container 30. The fitting 32 is configured to receive a portion of the foam pump 10 so as to secure the foam pump 10 to the fitting 32. For example, the fitting 32 can be sized to frictionally engage a portion of the foam pump 10 or to provide an interference fit therewith. In this way, the foam pump 10 and the coupling piece 40 can be pushed tight onto the plug 22. It will be understood that other ways of attachment are possible, for example, the foam pump 10 can be screwed onto, clamped onto, or bonded to the fitting 32.

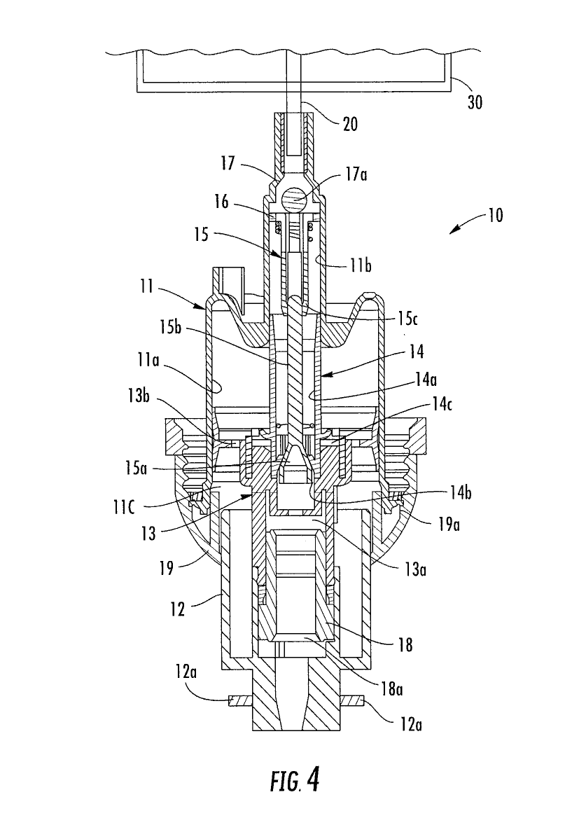

FIG. 3 illustrates the foam pump 10 in an exemplary rest position. The foam pump 10 is actuated by moving the nozzle 12 inwardly toward the pump chamber 11. During the compression stroke, actuation of the nozzle 12 leads to actuation of the air piston 13 and the liquid piston 14. As the liquid piston 14 slides into the fluid chamber 11b and the spring 16 is compressed, the ball check valve 17 is closed and the frustoconical end member 15a is unseated from the seat portion of the mixing chamber 14b. As a result, liquid soap is then forced from the fluid chamber 11b past the frustoconical end member 15a and into the mixing chamber 14b. At the same time, as the air piston 13 slides into the air chamber 11a, the valves 13b formed in the head of the air piston 13 are closed and pressurized air is forced from the air chamber 11a into the mixing chamber 14b through openings 14c. The pressurized air mixes with the liquid soap in the mixing chamber 14b and is forced out past the mesh or net elements 18 to create foam, which is expelled through the nozzle 12.

When the nozzle 12 is released, the spring 16 biases the liquid piston 14 and the plug 15c apart during the return stroke. Since the plug 15c is pressed initially against the ball check valve 17 and cannot move, the spring 16 urges the liquid piston 14 away from the plug 15c, thereby pushing the air piston 13 and the liquid piston 14 out of the air chamber 11a and fluid chamber 11b, respectively. This causes the valves 13b formed in the head of the air piston 13 to open for drawing air into the air chamber 13 from the outside.

Assuming that the air piston 13 and the liquid piston 14 are free to travel unobstructed during the return stroke, they will continue to do so until the spring 16 becomes fully uncompressed and the frustoconical end member 15a is received in the seat portion of the mixing chamber 14b. In principle, this arrangement seals the mixing chamber 14b, and thus the internal fluid passageway between the container 30 and the nozzle 12. The ball check valve 17 would also open and liquid soap would flow from the container 30 into the fluid chamber 11b.

However, in operation, the travel of the air piston 13 and the liquid piston 14 during the return stroke of the foam pump 10 may be impeded by frictional forces and various environmental effects, for example, soap residue that obstructs the travel of the liquid piston 14. In this case, the biasing force of the spring 16 may not be sufficient to overcome the resistance encountered by the air piston 13 and the liquid piston 14. As a result, the spring 16 will not be fully uncompressed in the rest position of the foam pump 10. In that case, the frustoconical end member 15a of the metering assembly 15 will not form a proper seal in the mixing chamber 14b and the foam pump 10 will potentially leak in the rest position. Similarly, even if the spring 16 returns to its fully uncompressed state in the rest position of the foam pump 10, manufacturing tolerances and wear over time may prevent the frustoconical end member 15a from consistently forming a proper seal in the mixing chamber 14b.

In order to ensure that the frustoconical end member 15a of the metering assembly 15 forms a proper seal in the mixing chamber 14b at the end of a stroke cycle, the foam pump 10 provides a clearance gap 11c between the head of the air piston 13 and the lower end of the air chamber 11a. Frictional forces acting between the head of the air piston 13 and the inner walls of the air chamber 11a normally prevent the air piston 13 from reaching the clearance gap 11c at the end of a return stroke, i.e., the rest position of the foam pump 10. However, by applying an external force to the nozzle 12, the air piston 13 can be moved into the clearance gap 11c. FIG. 4 illustrates this closed position of the foam pump 10. As the air piston 13 moves forward into the clearance gap 11c, the spring 16 is allowed to return to its fully uncompressed state and the seat portion of the mixing chamber 14 firmly engages the frustoconical end member 15a and is sealed.

### The Dispenser Assembly

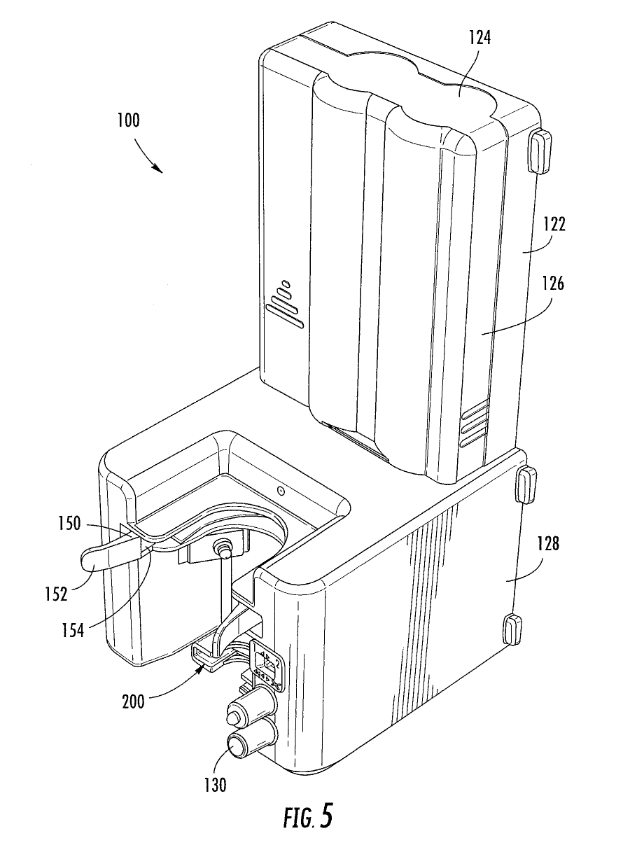

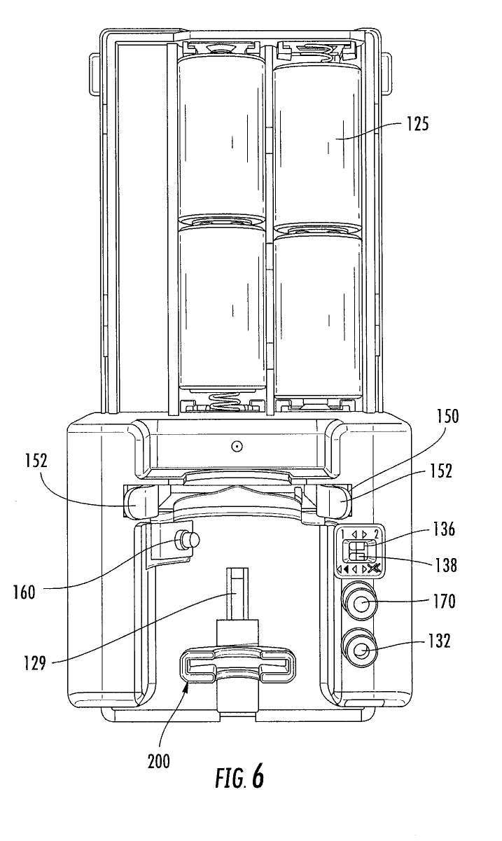

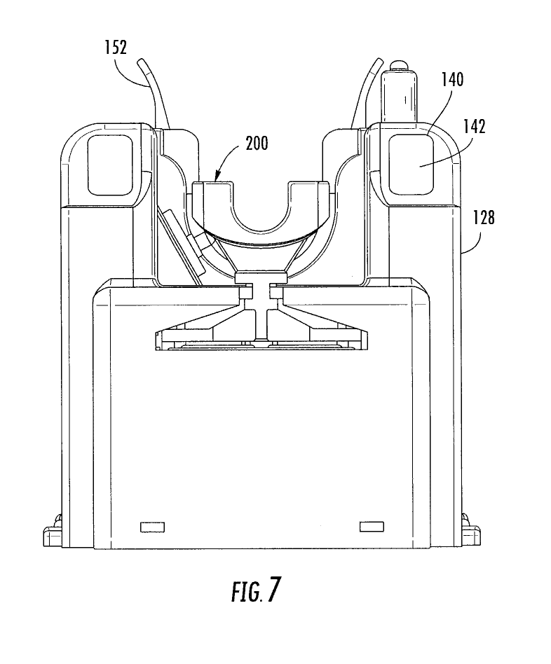

The dispenser assembly 100 has a housing 120 and a housing cover (not shown). FIGS. 5-6 display the dispenser assembly 100 with the housing cover removed. The housing 120 can be made of any durable material, but is preferably constructed of plastic. An upper portion 122 of the housing 120 includes an integrally molded battery compartment 124 with a detachable battery cover 126 mounted thereon in a known way. For example, the battery cover 126 can be press-fit directly into place or slid into a closed position. The battery compartment 124 holds a battery pack 125 for powering an actuating mechanism 200, which is discussed in greater detail below. The battery cover 126 can be opened or removed to facilitate replacing the battery pack 125. The battery pack 125 can be designed to contain various numbers and sizes of batteries. In the present embodiment, the dispenser contains four (4) C cell batteries. In an alternative embodiment, the energy source could be an alternating current source, which is well known in the art.

In the lower portion 128 of the housing 120, there is provided an indicator opening 130 to allow for visual access to a status indicator 132 of the dispenser assembly 100. The status indicator 132 can indicate, for example, whether the power level of the battery pack 125 is low, whether the container 30 is close to empty and needs to be replaced, or whether the dispenser assembly 100 is functioning appropriately, as well as other situations. In the present embodiment, the status indicator 132 is a set of light emitting diodes (LED) that act as a refill indicator and a low battery indicator. In particular, the status indicator blinks red to indicate that the container 30 is close to empty and blinks yellow to indicate that the power level of the battery pack 125 is low. In another embodiment, the status indicator 132 can be a liquid crystal display (LCD) or other display means. In addition to the status indicator 132, a speaker (not shown) can be provided to generate an audible indication of the status of the dispenser assembly 100.

In order to determine when the container 30 is close to empty and needs to be replaced, the dispenser assembly 100 can be provided with a timing circuit (not shown). The timing circuit contains an electronic counter that counts the actual number of doses dispensed from the container 30. Once the actual number of doses dispensed is greater than a preprogrammed threshold value, the timing circuit signals the status indicator to indicate that the container 30 is close to empty and should be replaced. The timing circuit resets once a refill container 30 is installed.

A set of switches 136 and 138 are provided in the lower portion 128 to control, respectively, the operation of the speaker 134 and the refill indicator function of the status indicator 132. In particular, the setting for the switch 138 programs the timing circuit with different threshold values. In this way, the status indicator 132 can provide an accurate refill indication for differently sized containers 30. Preferably, each threshold value corresponds to approximately ninety-five percent of the total amount of doses for a given container 30. In the present embodiment, for example, based on the flow rate through the foam pump 10, it is estimated that a 400 ml refill container provides about 1000 doses and a 800 ml refill container provides about 2000 doses. The setting for the switch 138 controls whether the threshold value for the timing circuit is set to 950 doses or 1900 doses, so as to provide, respectively, an accurate refill indication for either a 450 ml container or a 800 ml container.

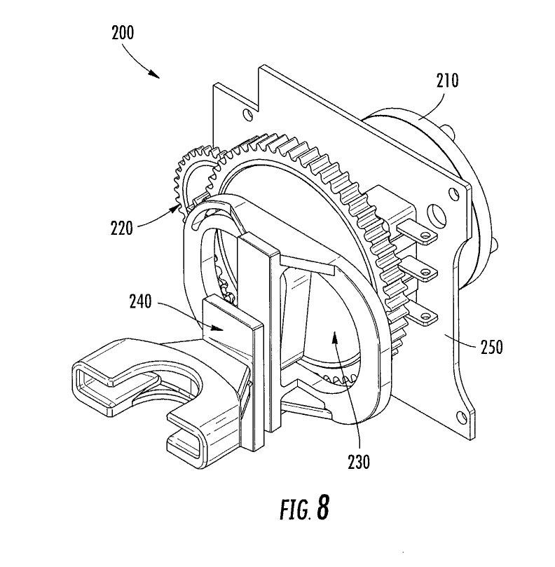

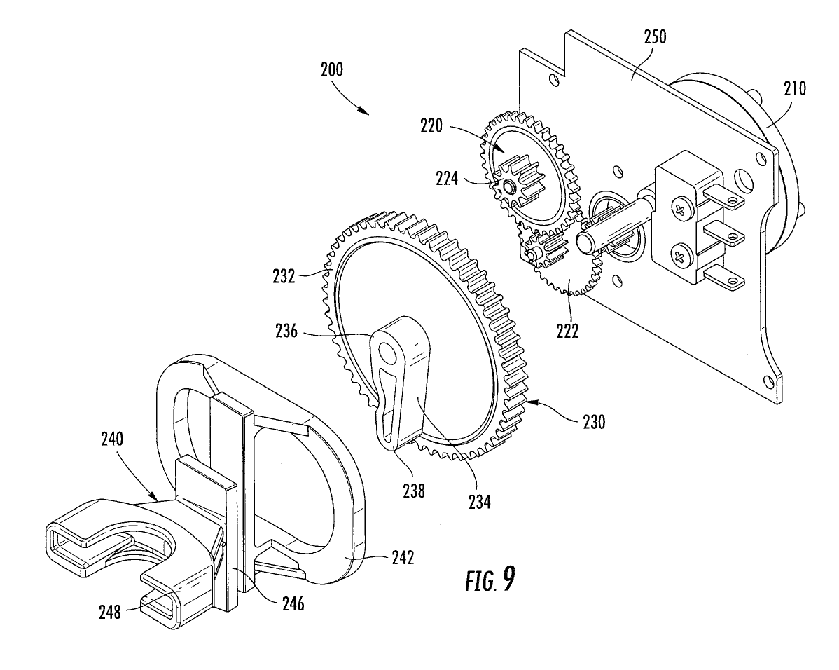

As shown in FIG. 7, the lower portion 128 of the housing 120 also contains a sensor assembly 140, including a sensor window 142 situated at the bottom of the dispenser assembly 100. The sensor window 142 can be made of any durable, clear or translucent material, including clear or translucent plastic. The sensor window 142 is designed to allow the sensor assembly 140 to detect the presence of a hand or other object below the dispenser assembly 100 in a position to receive a dose of foam. In the present embodiment, the sensor assembly 140 includes an infrared (IR) sensor that detects the presence of a hand below the dispenser. Alternatively, the sensor assembly 140 can include a capacitance sensor, or other sensing device designed to detect a hand or other object in the proximity of the dispenser. It will be understood that the sensor assembly 140, including the sensor window 140, can be positioned at different locations in the housing 120, or that alternatively, the sensor assembly 142 can be positioned away from the housing 130, without departing from the scope of the invention.

Upon sensing a user or object, the sensor assembly 140 sends an activation signal to a control circuit 190 that operates the dispenser assembly 100. The control circuit 190 is housed in the lower portion 128 of the housing 120 and is operatively connected to the sensor assembly 140, the battery pack 125, and the actuating mechanism 140. As explained below, the control circuit 190 processes the activation signal and activates the actuating mechanism 200 so as to actuate the foam pump 10 to dispense foam soap automatically without having to touch any switch or surface of the dispenser assembly. This improves the hygiene of the system by avoiding any potential cross contamination from previous users. The control circuit 190 then controls the actuating mechanism 200 so to return the foam pump 10 to its closed position to prevent dripping of excess soap.

The foam pump 10 is attached to the lower portion 128 of the housing 120 by way of an adapter 150 shown in FIGS. 5-6. The adapter 150 is configured to receive the foam pump 10, and in particular to connect to the coupling piece 40, for securing and positioning the foam pump 10 in the housing 120. In particular, the adapter 150 includes a pair of compliant latches 152, each of which has a recess 154 for engaging an outer cam surface 46 formed on the coupling piece 40 under tension. Thus, as shown in FIGS. 1-2, the coupling piece 40 is slid into the adapter 150 and locked in place by the two latches 152, which prevent unintended release during use. In another embodiment, the adapter 150 can also be provided with springs or other resilient means, not shown, for biasing the coupling piece 40 out of the adapter 150 when the latches 150 are moved away from the coupling piece 40, thereby facilitating the changing of the container 30, including the foam pump 10.

By these means, the foam pump 10 is rigidly coupled to the housing 120 during use so that the force exerted by the actuating mechanism 200 can move the nozzle 12 relative to the pump chamber 11. Differently designed matching combinations of the coupling piece 40 and the adapter 150 are possible. In one embodiment, the coupling piece 150 forms part of the dispenser assembly 100 and is included with it. Also, the foam pump 10 and the coupling piece 40 form part of the container 30 and are included with it. In this way, the dispenser assembly 100 can be customized to fit different containers 30. Of course it will be appreciated that by using a different adapter 150, the dispenser assembly 100 can be made suitable for use with different types of containers. It will be understood that a different type of locking of the coupling piece 40 is also possible.

The dispenser assembly 100 also contains a pump sensor 160 that is mounted in the lower portion 128 of the housing 120 proximate the adapter 150. The pump sensor 160 detects the presence of a foam pump 10 in the adapter 150. In addition, a cover sensor 170 is mounted on the housing 120 to detect when the housing cover is removed. The pump sensor 160 and the cover sensor 170 can signal the control circuit 190, for example, to shut off power to the actuating mechanism 200 while a refill container 30 is being installed or other maintenance is being performed on the dispenser assembly.

### The Actuating Mechanism

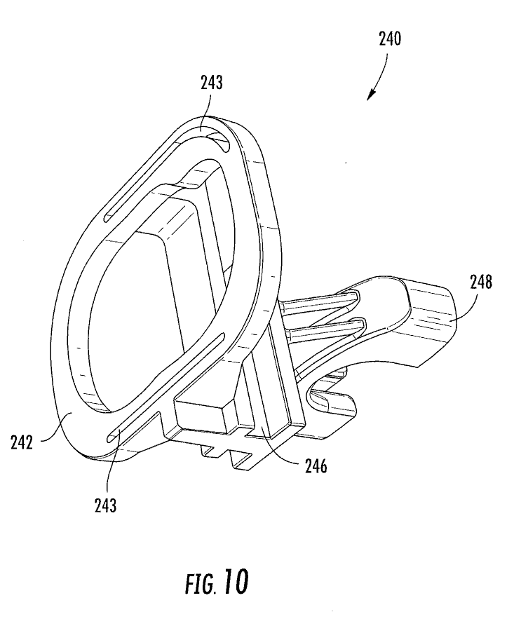

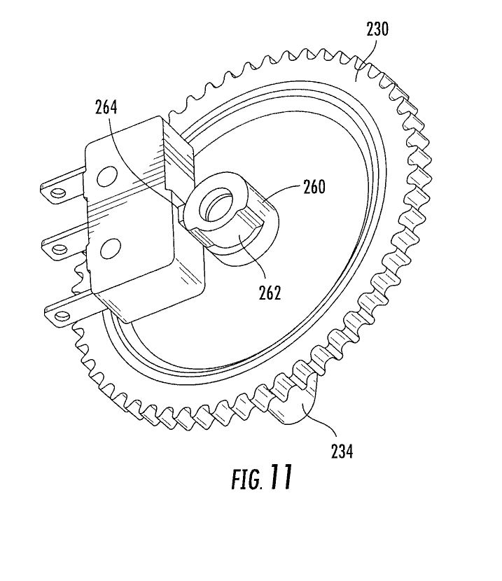

FIGS. 8-11 illustrate the actuating mechanism 200, including a motor 210 operatively connected to a hammer mechanism 240 through a reduction gear train 220 and a driving cam 230. The motor 210 is secured to the rear face of a mounting board 250, which is securely attached in the lower portion 128 of the housing 120 by a set of screws. The shaft of the motor 210 passes through an opening provided in the mounting board 250 in such a manner that the shaft engages the reduction gear train 220.

The reduction gear train 220 is mounted on the front face of the mounting board 250 opposite the motor 210 so as to reduce the speed and multiply the torque of the motor 210. An input gear 222 of the reduction gear train 220 is coupled to the shaft of the motor 210 for rotation therewith. The input gear 222 drives an output gear 224 of the gear train 220 through a series of intermediate gears that are rotatably supported on the mounting board 250.

The output gear 224 of the gear train 220 rotates the driving cam 230. The driving cam 230 includes a toothed wheel 232 which meshes with the output gear 224 and a pivot arm 234 which is fixed at its proximal end 236 to the shaft of the wheel 232 for rotation therewith. A switch cam 260 is also non-rotatably mounted on the shaft that supports the driving cam 230. The switch cam 260 has a cutout portion 262, including a convex surface which extends partially around the circumference of the switch cam 260. When the motor 210 is activated, the gear train 220 rotates the driving cam 230 and the switch cam 260. In this embodiment, the driving cam 230 and the switch cam 260 rotate through a complete revolution (360 degrees) during each stroke cycle of the foam pump 10.

The hammer mechanism 240 includes a loop member 242 connected to a “U” shaped adapter 248 via a guide section 246. The pivot arm 234 of the driving cam 230 is received in an opening formed in the loop member 242. The distal end 238 of the pivot arm 234 engages the loop member 242 so as to translate the rotational motion of the driving cam 230 into a linear motion for the hammer mechanism 240. In particular, as the driving cam 230 rotates, the distal end 238 of the pivot arm 234 moves in an arc about the pivot axis defined by the proximal end 236 and engages the inside upper and lower surfaces of the loop member 242, thereby urging the loop member 242 to move relative to driving cam 230. The loop member 242 includes flexible portions 243 to absorb variations in the dimensions of the elements of the actuating mechanism 200 and deflect impact forces cause by misalignment or external forces impeding the normal travel of the actuating mechanism 200.

The loop member 242 is rigidly attached to one end of the guide section 246. The guide section 246 is slidably disposed in a vertically oriented slot 129 formed in the lower portion 128 of the housing 120. The guide section 246 and the vertical slot 129 cooperate to prevent the hammer mechanism 240 from being horizontally displaced. The other end of the guide section 242 is rigidly attached to the “U” shaped adapter 248. In this manner, when the motor 210 turns the reduction gear 220 so as to rotate the driving cam 230, the driving cam 230 moves the hammer mechanism 240 in a generally linear vertical reciprocating motion relative to the housing 120.

The “U” shaped adapter 248 of the hammer mechanism 240 has a slotted opening configured to closely receive the protrusions or winged elements 12a of the nozzle 12. This allows the hammer mechanism 240 to engage and move the nozzle 12 so as to actuate the foam pump 10. The driving cam 230 and the hammer mechanism 240 are dimensioned and arranged within the housing 120 relative to the foam pump 10 so that when the pivot arm 234 of the driving cam 230 is facing downward parallel to the vertical axis of the hammer mechanism 240, the adapter 248 of the actuating mechanism 240 forces the foam pump 10 to its fully closed position via the nozzle 12.

Because the actuating mechanism 200 has a minimal number of moving parts and moves a minimal amount, the noise created during activation of the dispenser is minimized. Additionally, the minimal number of moving parts also reduces the likelihood of jamming or malfunction. Additionally, the use of a low torque motor and gears also reduces the noise during actuation.

### The Control Circuit

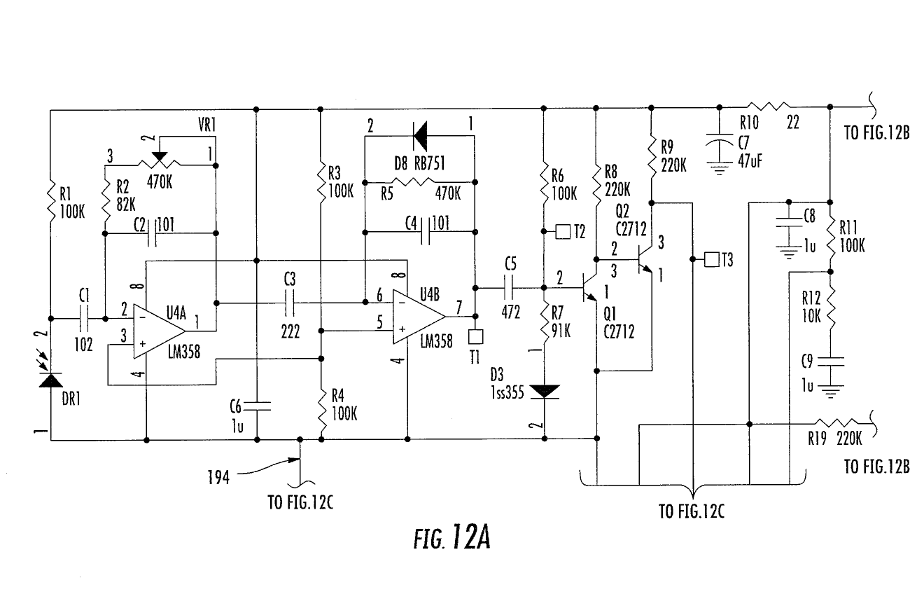

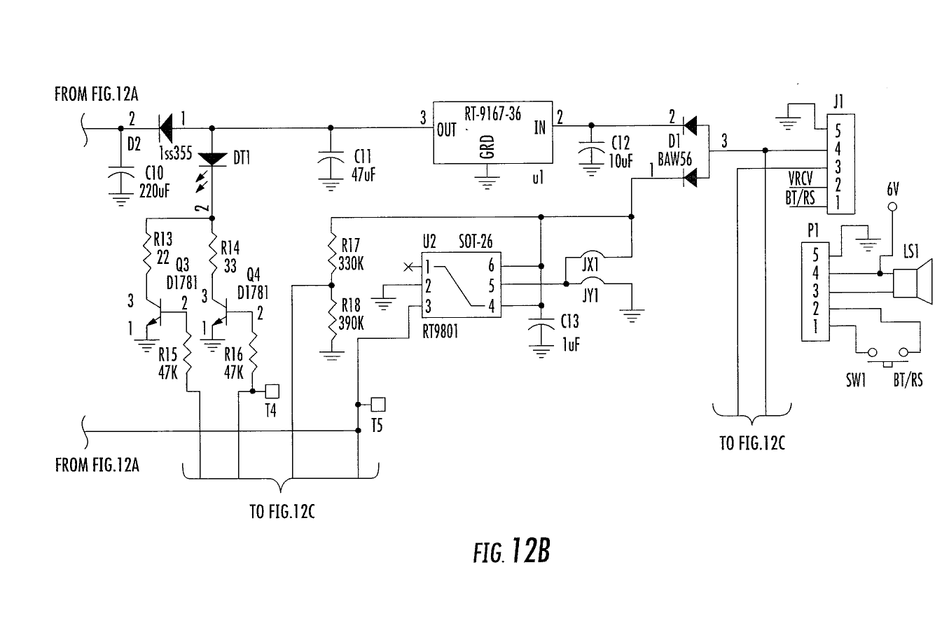

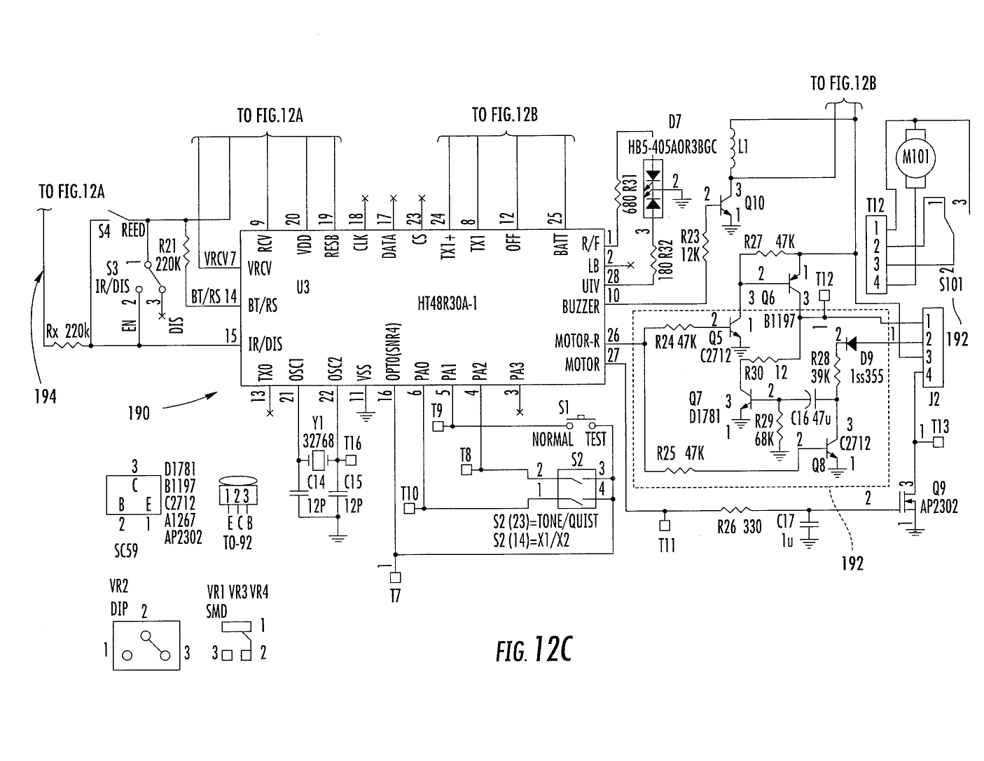

In operation, a control circuit 190, as shown in FIG. 12, processes the activation signal generated by the sensor assembly 140 upon sensing a user or object and directs power from the battery pack 125 to the actuating mechanism 200 to actuate the foam pump 10. When the actuating mechanism 200 is inactive, the pivot arm 234 of the driving cam 230 is facing generally downward, and is preferably oriented away from the vertical axis of the hammer mechanism 240 so as to reduce the likelihood of jamming or malfunction. Also, in the inactive state, the switch cam 260 is positioned such that a switch knob 264 of a micro switch S101 is in contact with the cutout portion 262 and is thereby released.

When the control circuit 190 activates the motor 210 to rotate the driving cam 230, the pivot arm 234 begins to pivot upwardly. As a result, the distal end 238 of the pivot arm 234 comes into contact with upper surface of the loop member 242, thereby driving the hammer mechanism 240 upwardly in the vertical slot 129 of the housing 120. Also, the switch knob 262 is brought out of contact with the cutout portion 260 and engages the outer surface of the switch cam 260, and is thereby depressed. The movement of the hammer mechanism 240 in upward direction moves the nozzle 12 of the foam pump 10 toward the pump chamber 11. As described above, during the compression stroke, the foam pump 10 mixes air and liquid soap to create foam, which is dispensed through the nozzle 12.

As the driving cam 230 continues to rotate, the pivot arm 234 begins to pivot downwardly. This allows the spring biased foam pump 10 to begin its return stroke. As the pivot arm 234 continues to pivot downwardly, the distal end 238 of the pivot arm 234 comes into contact with the lower surface of the loop member 242, thereby driving the hammer mechanism 240 downwardly in the vertical slot 129 and forcing the foam pump 10 to its fully closed position. The control circuit 190 will continue driving the actuating mechanism 240 until the switch knob 262 is again in contact with the cutout portion 262 of the switch cam 260 and is released. In this embodiment, the switch cam 260 is configured to release the switch knob 262 just after the pivot arm 234 of the driving cam 230 pivots past the vertical axis of the hammer mechanism 240 and the foam pump 10 is forced to its full closed position. Once the switch knob 262 is released, the control circuit 190 cuts the power from the battery pack 125 to the actuating mechanism 200 and brakes the motor 210 to ensure that the foam pump 10 is accurately returned to its closed position so as to prevent leaking.

In order to brake the motor 210, the control circuit 190 contains braking logic 192 including resistors R25, R28, R29, and R30, transistors Q7 and Q8, diode D9, capacitor C16 and micro switch S101. In the inactive state, terminals 1 and 2 of the micro switch S101 are closed and terminal 2 is connected to a 6V power supply so that the capacitor C16 is fully charged. When the control circuit 190 is triggered by an activation signal generated by the sensor assembly 140 as described above, the IC chip U3 will supply a short time pulse to motor driving logic 194 of the control circuit 190 so to activate the motor 210. This short time pulse is also used to discharge the capacitor C16 through resistor R25 and transistor Q8.

As the motor 210 begins to rotate the driving cam 230, the switch cam 260 engages the knob switch 262 to trigger the micro switch 192. This signals the control circuit 190 to disconnect power from the braking logic 192 and to connect power to the motor 210 through terminals 2 and 3 of micro switch S101. In this way, the motor 210 remains powered through the micro switch S101 even after the short time pulse generated by the IC chip U3.

At end of the stroke cycle, the switch knob 264 of the micro switch S101 is again brought into contact with the cutout portion 262 and is thereby released, as described above. This causes the control circuit 190 to disconnect power from motor 210 and to connect the braking logic 192 to the 6V power supply through terminals 2 and 3 of micro switch S101. When power to the motor 210 is disconnected, the motor 210 will still rotate because of the inertia of the rotator of motor 210. This rotation will create an electrodynamic potential on the motor terminals. Since the braking logic 192 is connected to the 6V power supply at this time, an up-going pulse will be generated on resistor R29 through diode D9, resistor R28 and capacitor C16. This pulse will trigger the transistor Q7 to turn on and to discharge the electrodynamic potential of motor through resistor R30, thereby effectively grounding the motor 210 so as to stop the motor 210 from rotating further. In this way, the control circuit 190 ensures precise positioning of the actuating mechanism 240, including the driving cam 230 and the hammer mechanism 240, and accurately forces the foam pump 10 to its fully closed position at the end of every stroke cycle.

Various embodiments of the invention have been described and illustrated. However, the description and illustrations are by way of example only. Other embodiments and implementations are possible within the scope of the invention and will be apparent to those of ordinary skill in the art.

For example, in another embodiment, the dispenser assembly may also contain circuitry that prevents the dispenser assembly 100 from operating when an object is continuously in the view of the sensor assembly 140. If the sensor assembly 140 has detected an object for more than thirty (30) seconds, the dispenser assembly will no longer dispense soap and will begin beeping. In this case, the dispenser assembly 100 will not continuously dispense soap in a situation where the sensor assembly 140 is blocked.

Therefore, the invention is not limited to the specific details of the representative embodiments, and illustrated examples in this description. Accordingly, the invention is not to be restricted except as necessitated by the accompanying claims and their equivalents.

1. An automatic dispenser assembly comprising:
a dispenser housing;
an actuating mechanism disposed in the dispenser housing for automatically actuating a pump assembly; and
a control circuit disposed in the dispenser housing for controlling the operation of the actuating mechanism so as to return the pump assembly to a fully closed position that prevents leaking at the end of a stroke cycle.

2. The automatic dispenser of claim 1 wherein the actuating mechanism comprises a motor.

3. The automatic dispenser of claim 2 further including a power supply for providing power to the motor.

4. The automatic dispenser of claim 3 wherein said control circuit includes a brake for stopping said motor when said pump assembly is in said fully closed position.

5. The automatic dispenser of claim 4 wherein said brake includes braking logic for stopping rotation of the motor.

6. The automatic dispenser of claim 5 further including a switch for disconnecting the power from the motor when said pump assembly is in the fully closed position.

7. The automatic dispenser of claim 6 wherein said switch connects the power to the braking logic when said pump assembly is in the fully closed position.

8. The automatic dispenser of claim 7 wherein rotation of said motor after said power is disconnected from the motor creates an up-pulse on the braking logic.

9. The automatic dispenser of claim 8 wherein said up-pulse discharges the electrodynamic potential of said motor to stop rotation of said motor.

10. The automatic dispenser of claim 1 wherein said pump assembly comprises an air chamber containing air and having an air piston movable therein and a fluid chamber containing a fluid and having a fluid piston movable therein.

11. The automatic dispenser of claim 10 wherein said actuating mechanism moves said air piston and said fluid piston from a rest position to an actuating position to force said air and said fluid into a mixing chamber to create a mixture of said air and said fluid.

12. The automatic dispenser of claim 11 further including a nozzle for dispensing said mixture of said air and said fluid.

13. The automatic dispenser of claim 1 said pump assembly movable between a first position where fluid is expelled by said pump assembly and said fully closed position.

14. The automatic dispenser of claim 13 further including a supply of a fluid connected to said pump assembly, wherein said pump assembly includes a first valve that is closed to prevent the flow of said fluid to said pump assembly when said pump assembly is in the first position.

15. The automatic dispenser of claim 14 wherein said first valve allows fluid to flow to said pump assembly when said pump assembly is in the fully closed position.

16. The automatic dispenser of claim 12 further including a second valve for allowing said mixture to flow to said nozzle.

17. The automatic dispenser of claim 16 wherein said second valve is open when said pump assembly is in the first position.

18. The automatic dispenser of claim 16 wherein said second valve is in a closed position when said pump assembly is in said fully closed position.

19. The automatic dispenser of claim 18 further including a spring for returning said second valve to said closed position.

20. The automatic dispenser of claim 18 wherein when said second valve is in said closed position, said actuating mechanism moves said air piston and said fluid piston to said rest position to place said pump assembly in said fully closed position.

21. The automatic dispenser of claim 20 wherein when said air piston and said fluid piston, when in said rest position, move said valve to said closed position.

22. The automatic dispenser of claim 21 wherein the actuating mechanism comprises a motor.

23. The automatic dispenser of claim 22 further including a power supply for providing power to the motor.

24. The automatic dispenser of claim 23 wherein said control circuit includes a brake for stopping said motor when said pump assembly is in said fully closed position.

25. The automatic dispenser of claim 24 wherein said brake includes braking logic for stopping rotation of the motor.

26. The automatic dispenser of claim 25 further including a switch for disconnecting the power from the motor when said pump assembly is in the fully closed position.

27. The automatic dispenser of claim 26 wherein said switch connects the power to the braking logic when said pump assembly is in the fully closed position.

28. The automatic dispenser of claim 27 wherein rotation of said motor after said power is disconnected from the motor creates an up-pulse on the braking logic.

29. The automatic dispenser of claim 28 wherein said up-pulse discharges the electrodynamic potential of said motor to stop rotation of said motor.
